(19) United States
(12) Patent Application Publication
(10) Pub. No.: US 2017/0365422 A1
(43) Pub. Date: Dec. 21, 2017

(54) KEY SWITCH

(71) Applicants: CITIZEN ELECTRONICS CO., LTD., Yamanashi-ken (JP); CITIZEN WATCH CO., LTD., Tokyo (JP)

(72) Inventor: Masashi WATANABE, Yamanashi-ken (JP)

(21) Appl. No.: 15/622,380

(22) Filed: Jun. 14, 2017

(30) Foreign Application Priority Data
Jun. 19, 2016 (JP) 2016-121311

(51) Int. Cl. H01H 13/14; H01H 13/50

(52) U.S. Cl. CPC H01H 13/14; H01H 13/50; H01H 2215/006

(57) ABSTRACT

A key switch includes a base plate, a key top, a pair of link members, and a switch mechanism. The key top is above the base plate. The link members support the key top and operate in an interlocked manner to allow the key top to be lifted and lowered with respect to the base plate. One of the link members includes a projecting portion at a distal end of an arm of the link member. The other one of the link members includes a concave receiving portion at a distal end of an arm of the link member. The projecting portion is rotationally fitted to the concave receiving portion. The switch mechanism is disposed between the base plate and the key top and is configured to open and close a contact portion of an electric circuit in accordance with lifting and lowering operation of the key top.

### CROSS-REFERENCE TO RELATED APPLICATIONS

The present application claims priority under 35 U.S.C. §119 to Japanese Patent Application No. JP2016-121311, filed Jun. 19, 2016. The contents of this application are incorporated herein by reference in their entirety.

### BACKGROUND OF THE INVENTION

### Field of the Invention

The present invention relates to a key switch mounted on, for example, a keyboard, or an input device of an electronic device such as personal computers.

### Discussion of the Background

Key switches have been proposed that include a base plate, a key top located above the base plate, a pair of V-shaped link members, and a switch mechanism (refer to Japanese Unexamined Patent Application Publication No. 2009-76321). The pair of V-shaped link members support the key top and operate in an interlocked manner to guide the key top in a lifting and lowering direction with respect to the base plate. The switch mechanism opens and closes a contact portion of an electric circuit in accordance with lifting and lowering operation of the key top. The pair of V-shaped link members are allowed to rotate in an interlocked manner by the engagement of teeth provided at the distal end portions of the link members. The pair of link members operate in an interlocked manner to allow the key top to be lifted and lowered in an approximately vertical direction with respect to the base plate while maintaining a predetermined position. Additionally, the switch mechanism includes a dome-shaped operation member made of a rubber material. With the lowering operation of the key top, the operation member is elastically deformed to close the contact portion of the electric circuit. With the lifting operation of the key top, the operation member is restored to an upper limit position so that the contact portion of the electric circuit is opened.

According to the above-mentioned conventional key switch, the link members operate in an interlocked manner by the engagement of the teeth at the distal ends of the link members. Thus, if a dimensional variation occurs during molding of the link members, or if the engagement between the teeth is insufficient due to displacement during mounting or during operation of the link members, the engagement between the teeth may be loosened, and the link members may possibly fail to operate smoothly in an interlocked manner.

Accordingly, it is an object of the present invention to provide a key switch in which a pair of link members are smoothly rotated in an interlocked manner without being influenced by a dimensional variation caused during molding of the link members.

It is another object of the present invention to provide a key switch that is shorter in height.

### SUMMARY OF THE INVENTION

A key switch according to one aspect of the present invention includes a base plate, a key top, a pair of link members, and a switch mechanism. The key top is above the base plate. The pair of link members support the key top and are configured to operate in an interlocked manner to allow the key top to be lifted and lowered with respect to the base plate. One of the pair of link members includes a projecting portion at a distal end of an arm of the link member. The other one of the pair of link members includes a concave receiving portion at a distal end of an arm of the link member. The projecting portion is rotationally fitted to the concave receiving portion. The switch mechanism is disposed between the base plate and the key top and is configured to open and close a contact portion of an electric circuit in accordance with lifting and lowering operation of the key top.

A key switch according to another aspect of the present invention includes a base plate, a key top, a pair of link members, and a switch mechanism. The key top is above the base plate. The pair of link members support the key top and are configured to operate in an interlocked manner to allow the key top to be lifted and lowered with respect to the base plate. The switch mechanism is disposed between the base plate and the key top and is configured to open and close a contact portion of an electric circuit in accordance with lifting and lowering operation of the key top. The switch mechanism includes a sheet-shaped switch member, a plate-shaped spring member, and a housing. The sheet-shaped switch member is disposed on an upper surface of the base plate and includes a contact portion of an electric circuit. The plate-shaped spring member is above the contact portion of the electric circuit. The housing is secured to the base plate and accommodates the plate-shaped spring member.

With the key switch according to one aspect of the present invention, one of the pair of link members includes the projecting portion at the distal end of the arm of the link member. The other one of the pair of link members includes the concave receiving portion at the distal end of the arm of the link member. The projecting portion is rotationally fitted to the concave receiving portion. Thus, the pair of link members are operated smoothly in an interlocked manner without backlash at the coupling portion.

The key switch according to another aspect of the present invention includes the plate-shaped spring member instead of a conventional dome-shaped operation member made of a rubber material. This configuration makes the key switch shorter in height.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is an exploded perspective view of a key switch according to a first embodiment of the present invention;

FIG. 2 is a perspective view of a plate-shaped spring member of the key switch according to the first embodiment of the present invention;

FIG. 3 is a perspective view of a base plate of the key switch according to the first embodiment of the present invention illustrating a state in which a switch mechanism is mounted on the base plate;

FIG. 4 is a perspective view of a pair of link members of the key switch according to the first embodiment of the present invention illustrating a state in which a key top is mounted on the pair of link members;

FIG. 5 is a perspective view of the key switch according to the first embodiment of the present invention;

FIG. 6A is a cross-sectional view taken along the line 6A-6A of FIG. 5 when the key top is at an upper limit position;

FIG. 6B is a cross-sectional view taken along the line 6B-6B of FIG. 5 when the key top is at the upper limit position;

FIG. 6C is a cross-sectional view taken along the line 6C-6C of FIG. 5 when the key top is at the upper limit position;

FIG. 6D is a cross-sectional view taken along the line 6D-6D of FIG. 5 when the key top is at the upper limit position;

FIG. 7A is a cross-sectional view taken along the line 6A-6A of FIG. 5 when the key top is at a lower limit position;

FIG. 7B is a cross-sectional view taken along the line 6B-6B of FIG. 5 when the key top is at the lower limit position;

FIG. 7C is a cross-sectional view taken along the line 6C-6C of FIG. 5 when the key top is at the lower limit position;

FIG. 7D is a cross-sectional view taken along the line 6D-6D of FIG. 5 when the key top is at the lower limit position;

FIG. 8 is a perspective view of a plate-shaped spring member of a key switch according to a second embodiment of the present invention; and

FIG. 9 is a cross-sectional view of the plate-shaped spring member of the key switch according to the second embodiment of the present invention illustrating a state in which the plate-shaped spring member is elastically deformed.

### DESCRIPTION OF THE EMBODIMENTS

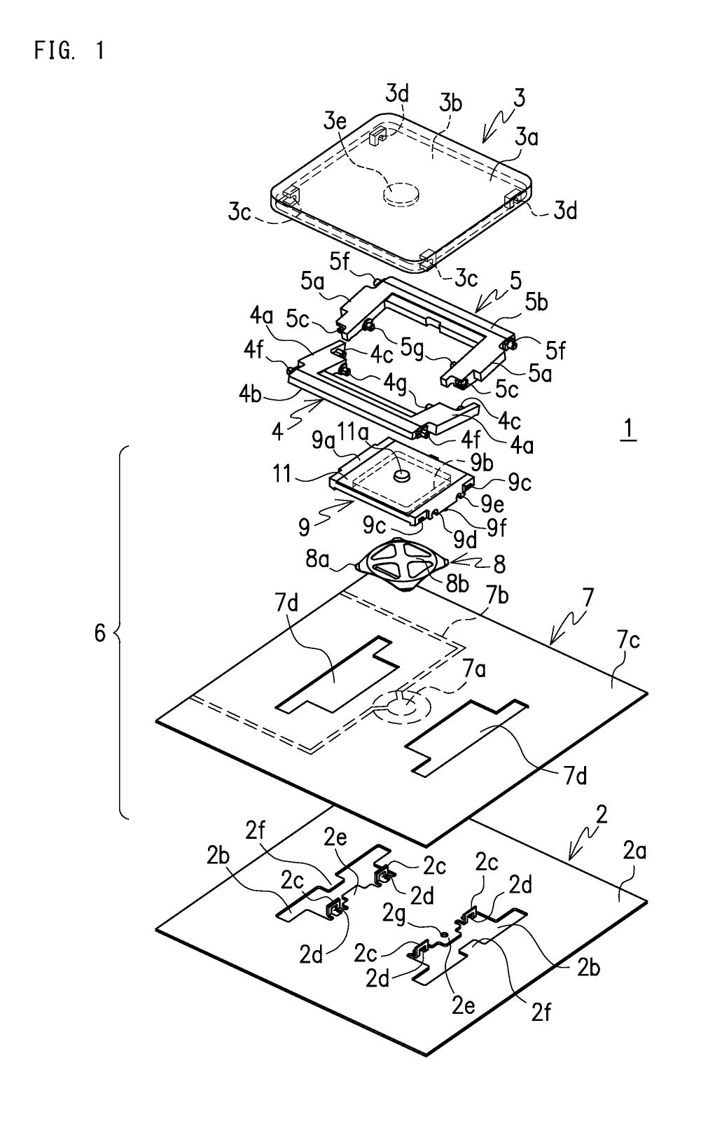

Hereinafter, a key switch according to an embodiment of the present invention will be described in detail with reference to the attached drawings. FIGS. 1 to 7D illustrate a key switch 1 according to a first embodiment of the present invention. The key switch 1 includes a rectangular base plate 2, a key top 3, a pair of link members 4 and 5, and a switch mechanism 6. The key top 3 is located above the base plate 2. The switch mechanism 6 is located between the base plate 2 and the key top 3 and opens and closes a contact portion of an electric circuit in accordance with lifting and lowering operation of the key top 3. The pair of link members 4 and 5 have an approximately identical U-shape to each other. The pair of link members 4 and 5 support the key top 3 and operate in an interlocked manner to allow the key top 3 to be lifted and lowered with respect to the base plate 2. The switch mechanism 6 is located between the base plate 2 and the key top 3, and more specifically, on an upper surface 2a of the base plate 2. The switch mechanism 6 includes a sheet-shaped switch member 7, a plate-shaped spring member 8, and a housing 9. The sheet-shaped switch member 7 includes a contact portion 7a of the electric circuit. The plate-shaped spring member 8 is located on the contact portion 7a of the electric circuit. The housing 9 accommodates the plate-shaped spring member 8 and is secured to the base plate 2.

The base plate 2 is made of a plastic plate or a metal plate that are rigid and tabular. The base plate 2 includes the flat upper surface 2a. The base plate 2 includes a pair of symmetrical open windows 2b provided on left and right sections along the long sides of the base plate 2. The open windows 2b are basically rectangular. A pair of engaging portions 2c are provided on the inner edge of each open window 2b. The pair of engaging portions 2c of one of the open windows 2b face the pair of engaging portions 2c of the other open window 2b. The engaging portions 2c are formed by punching and bending parts of the base plate 2 in an inverted U-shape. Each of the engaging portions 2c includes an engaging hole 2d. The engaging holes 2d respectively receive engaging projections 9c. The engaging projections 9c project from the outer surfaces on the left and right sides of a frame 9a of the housing 9. Each of the pair of open windows 2b also includes a rectangular inner extended portion 2e provided on the inner edge at a position sandwiched between the associated two engaging portions 2c. Each of the pair of open windows 2b further includes an outer extended portion 2f on the outer edge at a position opposing the associated inner extended portion 2e. One of the two inner extended portions 2e includes a positioning hole 2g. The positioning hole 2g is used when the housing 9 is placed on the upper surface 2a of the base plate 2. Additionally, as discussed below, each outer extended portion 2f functions as a stopper for controlling an upper limit position during lifting and lowering operation of the key top 3. That is, when the pair of link members 4 and 5 are rotated in an interlocked manner, the distal ends of at least one of the link members 4 and 5 abut against the upper surfaces of the outer extended portions 2f so that the rotation of the link members 4 and 5 is limited.

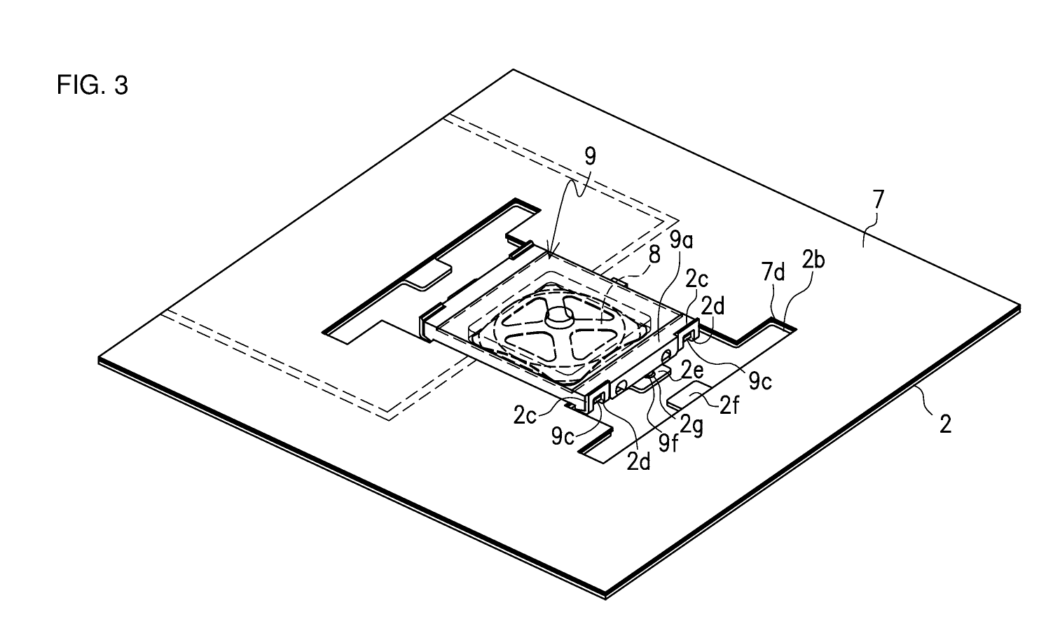

The sheet-shaped switch member 7 includes, for example, a membrane switch and is placed on the upper surface 2a of the base plate 2. The membrane switch 7 includes a flexible circuit substrate 7c. The flexible circuit substrate 7c includes a pair of opposing contacts and an electric circuit 7b that extends from the contacts. The contacts and the electric circuit 7b are formed by patterning. The contact portion 7a is configured such that the pair of contacts are kept in an opened state. The membrane switch 7 includes a pair of open windows 7d. The open windows 7d have approximately the same basic shape as the open windows 2b, which are provided on the base plate 2. As illustrated in FIG. 3, the pair of open windows 7d are provided at positions that approximately coincide with the pair of open windows 2b of the base plate 2 when the membrane switch 7 is placed on the upper surface 2a of the base plate 2. The engaging portions 2c, the inner extended portions 2e, and the outer extended portions 2f, which are provided on the base plate 2, are exposed from the pair of open windows 7d of the membrane switch 7.

The key top 3 is made of a plastic mold and is a square or rectangular tabular member as viewed from the top. The key top 3 includes an upper surface 3a that serves as a manipulation surface. The key top 3 also includes guide grooves provided on the underside of the upper surface 3a. The guide grooves rotationally support one edge of each of the pair of link members 4 and 5. The guide grooves are provided at positions adjacent to four corners of the inner circumferential surface of a recess 3b on the inner side of the key top 3. The guide grooves include a pair of horizontal guide grooves 3c provided at the front end corners of the recess 3b and a pair of vertical guide grooves 3d provided at the rear end corners of the recess 3b. The key top 3 includes a columnar projection 3e that slightly projects downward from the center of the recess 3b. The columnar projection 3e is formed integrally with the key top 3.

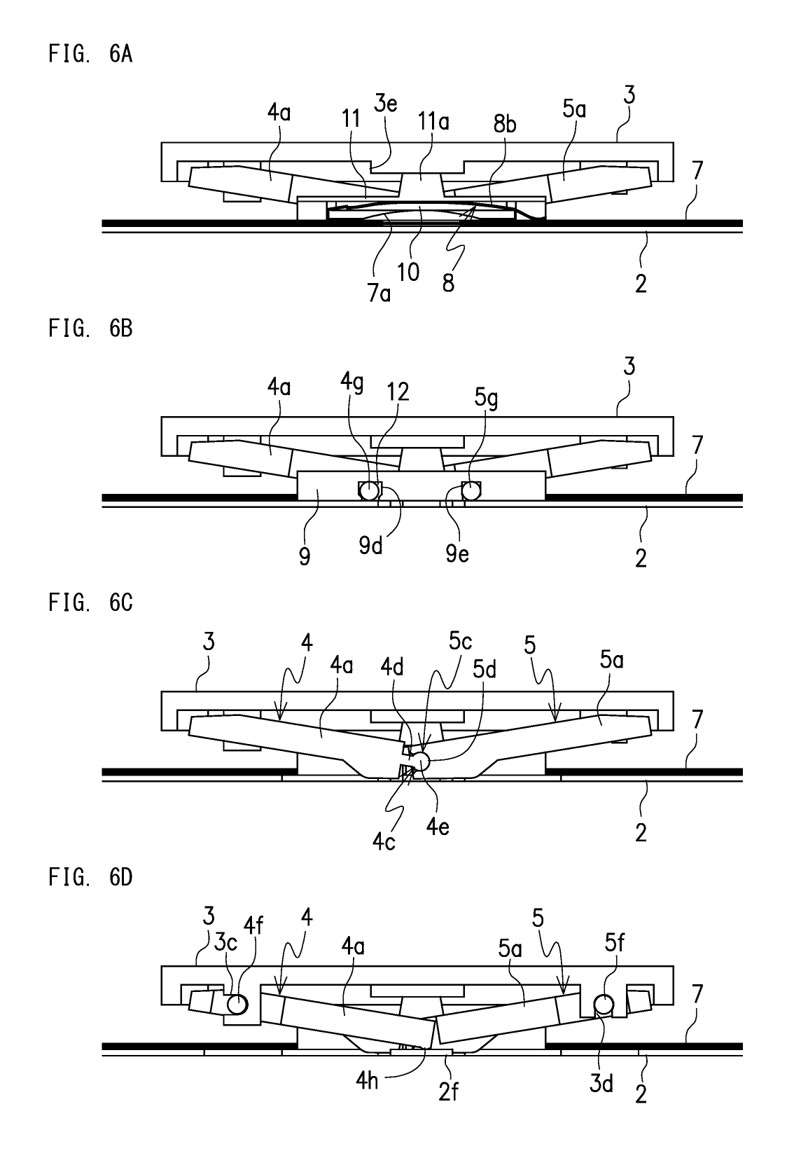

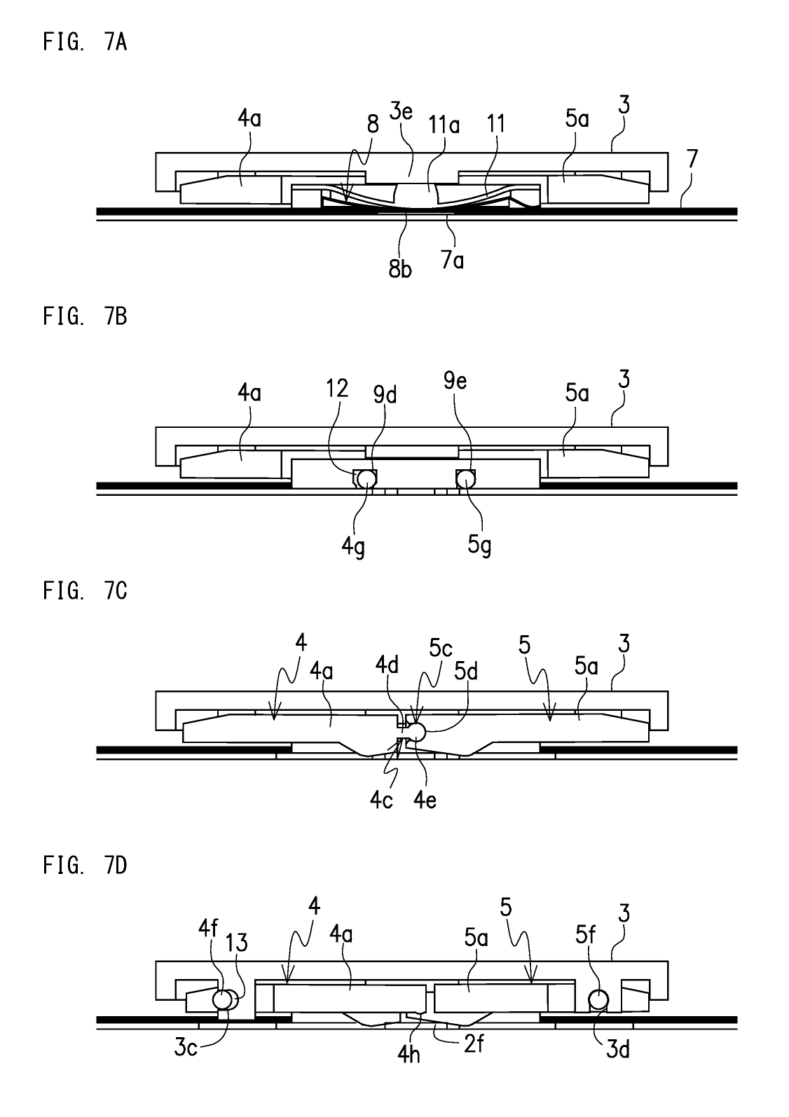

The U-shaped link members 4 and 5 are made of plastic molds. The link member 4 includes left and right pair of arms 4a that extend parallel to each other in the same direction and a coupling portion 4b that couples the left and right pair of arms 4a with each other. Similarly, the link member 5 includes left and right pair of arms 5a that extend parallel to each other in the same direction and a coupling portion 5b that couples the left and right pair of arms 5a with each other. The pair of link members 4 and 5 are coupled by fitting the distal ends of the pair of arms 4a to the distal ends of the pair of arms 5a. The link members 4 and 5 are rotated in an interlocked manner about the above-mentioned fitting portions. More specifically, the left and right pair of arms 4a of the link member 4 each include a projecting portion 4c provided at the distal end. The left and right pair of arms 5a of the link member 5 each include a concave receiving portion 5c provided at the distal end. The projecting portions 4c are rotationally fitted to the concave receiving portions 5c. As illustrated in FIGS. 6C and 7C, each projecting portion 4c includes a base portion 4d and a columnar body 4e provided at the distal end of the base portion 4d. The diameter of the columnar body 4e is greater than the diameter of the base portion 4d. The concave receiving portion 5c includes a curved inner circumferential portion 5d that corresponds to the arc shape of the columnar body 4e such that the columnar body 4e of the projecting portion 4c is fitted in the concave receiving portion 5c. Since the projecting portions 4c are fitted in the concave receiving portions 5c, the link members 4 and 5 are more reliably coupled to each other. As a result, even if a dimensional variation occurs during molding of the link members 4 and 5, backlash is unlikely to occur when the link members 4 and 5 are fitted to each other. This configuration also allows the pair of link members 4 and 5 to smoothly rotate in an interlocked manner and the key top 3 to be smoothly lifted and lowered.

The pair of link members 4 and 5 are rotationally supported by the key top 3 and the housing 9, which will be discussed below. The left and right pair of arms 4a of the link member 4 each include a support pin 4f that projects outward from the outer surface at the rear end portion of each arm 4a. Similarly, the left and right pair of arms 5a of the link member 5 each include a support pin 5f that projects outward from the outer surface at the rear end portion of each arm 5a. The support pins 4f and 5f support the pair of link members 4 and 5 on the key top 3. The support pins 4f, which are provided on the link member 4, are rotationally fitted in and supported by the pair of horizontal guide grooves 3c, which are provided at the front end corners of the key top 3. Similarly, the support pins 5f, which are provided on the link member 5, are rotationally fitted in and supported by the pair of vertical guide grooves 3d, which are provided at the rear end corners of the key top 3.

Additionally, the left and right pair of arms 4a of the link member 4 each include a support pin 4g that projects inward from the inner surface of each arm 4a. Similarly, the left and right pair of arms 5a of the link member 5 each include a support pin 5g that projects inward from the inner surface of each arm 5a. The link members 4 and 5 are rotationally supported by the housing 9 with the support pins 4g and 5g.

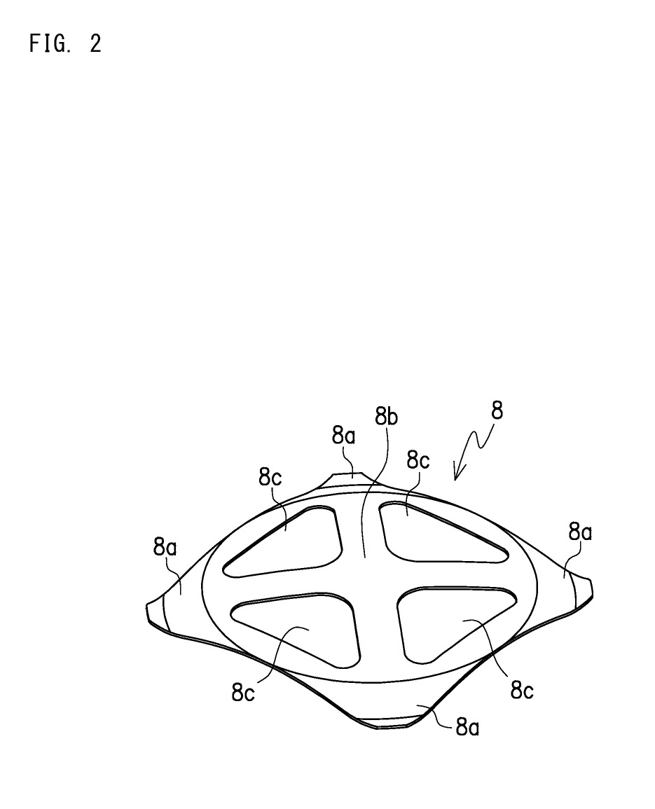

The plate-shaped spring member 8 is located on the contact portion 7a of the membrane switch 7. As illustrated in FIGS. 1 and 2, the plate-shaped spring member 8 is formed of a thin plate having spring characteristics into an approximately rectangular shape as a whole. The plate-shaped spring member 8 includes legs 8a at four corners on the outer edge. The plate-shaped spring member 8 includes a dome-shaped slightly bulging circular depression portion 8b at the central portion. The legs 8a are inclined from the depression portion 8b toward the distal ends. As illustrated in FIG. 6A, when the plate-shaped spring member 8 is placed, a space 10 is provided between the inner side of the depression portion 8b and the contact portion 7a of the membrane switch 7 to allow the depression portion 8b to be elastically deformed. Thus, the depression portion 8b reliably provides a tactile feeling. As illustrated in FIG. 2, the depression portion 8b also includes four identical holes 8c over approximately the entire surface in this embodiment. The four holes 8c are provided over the entire depression portion 8b so that the depression portion 8b is elastically deformed easily to provide a soft tactile feeling. The shape and the size of the holes 8c may be redesigned as required to adjust the tactile feeling obtained when the depression portion 8b is pressed.

The plate-shaped spring member 8 is accommodated in the housing 9, which is located above the spring member 8. The housing 9 includes the frame 9a integrally formed of a plastic material into a rectangular shape. The frame 9a defines, on the inner side, a rectangular hollow portion 9b that accommodates the plate-shaped spring member 8. The plate-shaped spring member 8, which is accommodated in the hollow portion 9b, is retained by abutting the distal ends of the four legs 8a against four corners of the hollow portion 9b. The hollow portion 9b of the housing 9 is covered with a sheet-shaped member 11 from above to prevent the plate-shaped spring member 8 from springing out upward. The sheet-shaped member 11 is made of a thin plastic sheet having elasticity. The outer circumferential portion of the sheet-shaped member 11 is bonded to the upper surface of the frame 9a of the housing 9. The sheet-shaped member 11 is capable of being elastically deformed when the sheet-shaped member 11 is pressed from above. The housing 9 further includes four engaging projections 9c (the engaging projections provided on the left side of the frame 9a are not illustrated in FIG. 1) located adjacent to the front and rear ends of the outer surfaces on the left and right sides of the frame 9a of the housing 9. The engaging projections 9c are to be respectively inserted in the engaging holes 2d of the engaging portions 2c, which are provided on the base plate 2.

The housing 9 further includes support grooves 9d and support grooves 9e at positions adjacent to the engaging projections 9c. The support grooves 9d are located close to the front ends of the left and right sides of the frame 9a. The support grooves 9e are located close to the rear ends of the left and right sides of the frame 9a (the support grooves provided on the left side of the frame 9a are not illustrated in FIG. 1). The support grooves 9d receive the support pins 4g, which are provided on the inner side of the left and right pair of arms 4a of the link member 4, and the support grooves 9e receive the support pins 5g, which are provided on the inner side of the left and right pair of arms 5a of the link member 5. The support pins 4g and 5g of the link members 4 and 5 are rotationally fitted to and supported by the support grooves 9d and 9e of the housing 9, which is secured to the base plate 2, so that the pair of link members 4 and 5 are rotational about the support pins 4g and 5g. As illustrated in FIGS. 6B and 7B, each support pin 4g is supported by one of the support grooves 9d with a gap 12 formed in between. Thus, when the pair of link members 4 and 5 are rotated, the arms 4a are allowed to slide in the horizontal direction.

The sheet-shaped member 11 includes a circular truncated conical projection 11a at the central portion of the upper surface of the sheet-shaped member 11. The circular truncated conical projection 11a is a short circular truncated cone and is formed integrally with the sheet-shaped member 11. The circular truncated conical projection 11a is located at a position corresponding to the depression portion 8b of the plate-shaped spring member 8. The circular truncated conical projection 11a is also located at a position corresponding to the columnar projection 3e, which is shorter in height and is provided on the inner side of the key top 3.

The key switch 1, which includes the above-described components, is produced as follows. As illustrated in FIG. 3, first, the membrane switch 7 is placed on the base plate 2 to align the open windows 7d of the membrane switch 7 with the open windows 2b of the base plate 2, and the membrane switch 7 is bonded to the base plate 2. Subsequently, the plate-shaped spring member 8 is placed on the contact portion 7a of the membrane switch 7, and the housing 9 is placed to cover the plate-shaped spring member 8 from above. The housing 9 is positioned by aligning a positioning pin 9f with the positioning hole 2g, which is provided on one of the inner extended portions 2e of the base plate 2. The positioning pin 9f projects from the lower surface of the frame 9a of the housing 9. Additionally, the engaging projections 9c, which are provided on the left and right sides of the frame 9a of the housing 9, are inserted in the engaging holes 2d of the engaging portions 2c, which are provided on the base plate 2, to be engaged so that the housing 9 is secured to the base plate 2.

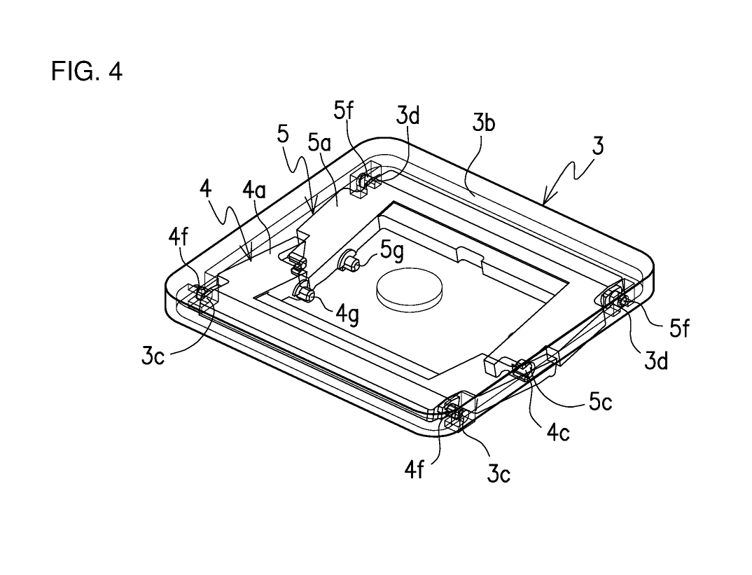

FIG. 4 illustrates a state in which the pair of link members 4 and 5 are mounted on the key top 3. The pair of link members 4 and 5 are rotationally coupled to each other by fitting the projecting portions 4c, which are provided at the distal ends of the left and right pair of arms 4a, to the concave receiving portions 5c, which are provided at the distal ends of the left and right pair of arms 5a. The pair of link members 4 and 5 are supported by the key top 3 by fitting the support pins 4f and 5f to the horizontal guide grooves 3c and the vertical guide grooves 3d, which are provided at the four corners of the recess 3b of the key top 3. As illustrated in FIGS. 6D and 7D, each support pin 4f is supported by the associated horizontal guide groove 3c with a gap 13 formed in between. Thus, when the pair of link members 4 and 5 are rotated, the arms 4a are allowed to slide in the horizontal direction.

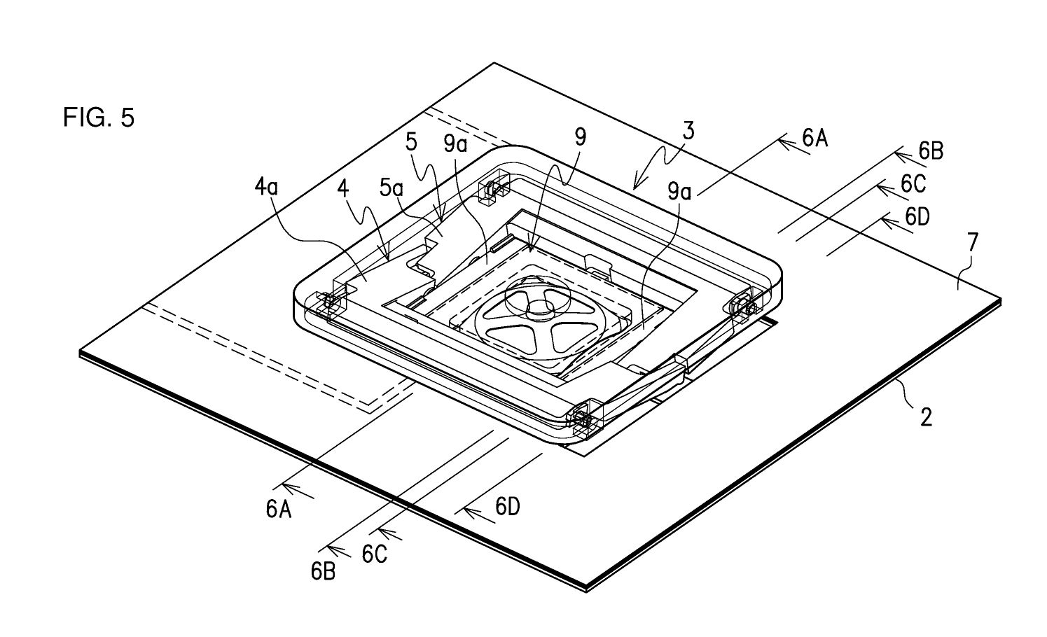

FIG. 5 illustrates a state in which the link members 4 and 5, which are supported by the key top 3, are mounted on the base plate 2. The pair of link members 4 and 5 are placed over the housing 9 in a state in which the pair of link members 4 and 5 are mounted on the key top 3. The link member 4 is supported by the housing 9 by rotationally fitting the support pins 4g (refer to FIG. 4), which are provided on the inner surface of the left and right pair of arms 4a, to the support grooves 9d (refer to FIG. 1), which are provided on the left and right sides of the frame 9a of the housing 9. The link member 5 is supported by the housing 9 by rotationally fitting the support pins 5g (refer to FIG. 4), which are provided on the inner surface of the left and right pair of arms 5a, to the support grooves 9e (refer to FIG. 1), which are provided on the left and right sides of the frame 9a of the housing 9.

Next, operation of the key switch 1 according to the present embodiment will be described with reference to FIGS. 6A to 6D and FIGS. 7A to 7D. FIGS. 6A to 6D illustrate a state in which the key top 3 is at the upper limit position. The pair of link members 4 and 5 form a V-shape when the key top 3 is at the upper limit position of the lifting and lowering operation. As illustrated in FIG. 6A, the upper surface of the circular truncated conical projection 11a on the sheet-shaped member 11, which covers the upper surface of the housing 9, contacts the columnar projection 3e on the inner surface of the key top 3. The plate-shaped spring member 8 above the contact portion 7a contacts the lower surface of the sheet-shaped member 11 so that the depression portion 8b is retained. Thus, the contact portion 7a of the membrane switch 7 is in an opened state. Furthermore, as illustrated in FIG. 6D, distal end portions 4h of the arms 4a of the link member 4 abut against the outer extended portions 2f of the open windows 2b of the base plate 2. This configuration controls the upper limit position of the lifting and lowering operation of the key top 3.

As illustrated in FIGS. 6C and 7C, the pair of link members 4 and 5 are rotated in an interlocked manner by fitting the projecting portions 4c, which are provided at the distal ends of the arms 4a, to the concave receiving portions 5c, which are provided at the distal ends of the arms 5a. Additionally, as illustrated in FIGS. 6D and 7D, the support pins 4f, which are provided at the rear ends of the arms 4a, are rotationally supported by the horizontal guide grooves 3c of the key top 3. Similarly, the support pins 5f, which are provided at the rear ends of the arms 5a, are rotationally supported by the vertical guide grooves 3d of the key top 3. Furthermore, as illustrated in FIGS. 6B and 7B, the support pins 4g, which are provided at the front ends of the arms 4a, are rotationally supported by the support grooves 9d of the housing 9. Similarly, the support pins 5g, which are provided at the front ends of the arms 5a, are rotationally supported by the support grooves 9e of the housing 9. Since the support pins 4f and 4g are supported in a state in which the gaps 13 and 12 are respectively provided in the horizontal guide grooves 3c and the support grooves 9d, when the pair of link members 4 and 5 are rotated, the link member 4 is allowed to slide in the horizontal direction in the gaps 13 and 12. Thus, the pair of link members 4 and 5 are smoothly operated in an interlocked manner.

FIGS. 7A to 7D illustrate a state in which the key top 3 is at a lower limit position of the lifting and lowering operation. When the key top 3 is depressed, the pair of link members 4 and 5 are rotated in an interlocked manner such that the shape of the pair of link members 4 and 5 changes from a V-shape to a flat shape. The rotation of the link members 4 and 5 lowers the key top 3. As illustrated in FIG. 7A, the columnar projection 3e presses the circular truncated conical projection 11a and deforms the sheet-shaped member 11 downward to press the plate-shaped spring member 8 downward. The depression portion 8b of the pressed plate-shaped spring member 8 is elastically deformed to curve, and the plate-shaped spring member 8 contacts the contact portion 7a of the membrane switch 7 so that the contact portion 7a is closed. When a finger is removed from the upper surface of the key top 3, depression is released, and the plate-shaped spring member 8 pushes the sheet-shaped member 11 upward by the elastic restoration force of the plate-shaped spring member 8. At this time, the plate-shaped spring member 8 pushes the key top 3 upward via the circular truncated conical projection 11a and the columnar projection 3e. Accordingly, the pair of link members 4 and 5 move in an interlocked manner to form a V-shape again. The upper limit position of the key top 3 is controlled by the stoppers as described above.

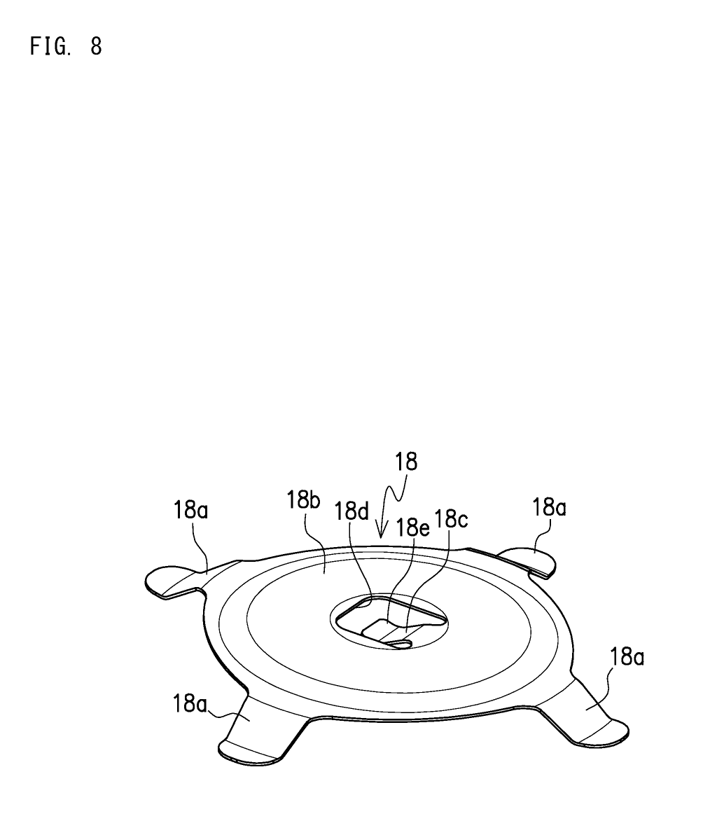

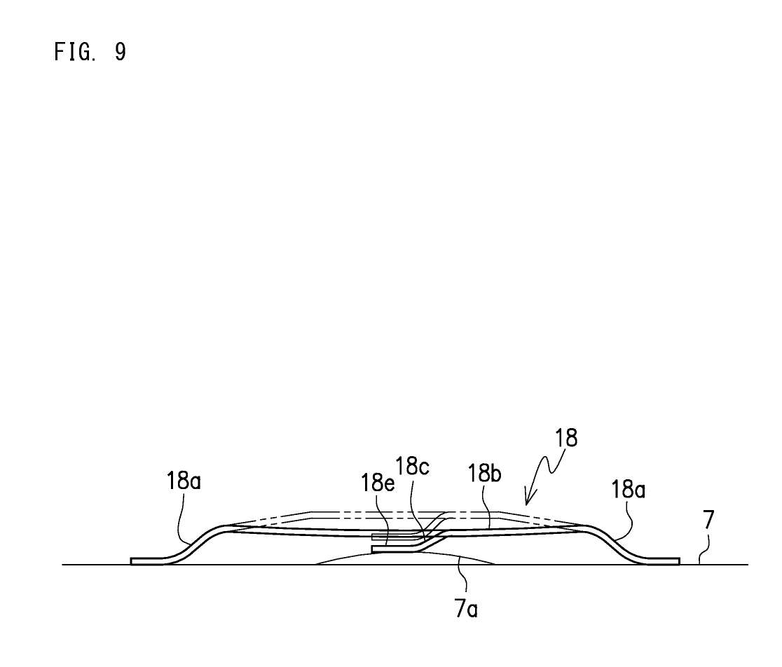

FIGS. 8 and 9 illustrate a plate-shaped spring member 18 according to a second embodiment. The plate-shaped spring member 18 according to this embodiment includes a disk-shaped depression portion 18b and four legs 18a at the periphery of the depression portion 18b. The depression portion 18b includes a depression piece 18c that is pressed to contact with the contact portion 7a of the membrane switch 7. The depression piece 18c is formed of a punched and bent piece that is formed by punching and bending the central portion of the depression portion 18b. The depression portion 18b includes a rectangular punched hole 18d at the central portion of the depression portion 18b. The punched hole 18d is provided by forming a slit in the depression portion 18b in a U-shape. The edge portion of the punched hole 18d without the slit is coupled to the depression portion 18b. The punched and bent piece is formed by bending the edge portion of the punched hole 18d toward the lower surface of the depression portion 18b. The depression piece 18c includes a flat portion 18e at the distal end portion. In the plate-shaped spring member 18, the depression piece 18c is elastically deformed in addition to the depression portion 18b, and the flat portion 18e of the depression piece 18c directly presses the contact portion 7a of the membrane switch 7. Thus, in the plate-shaped spring member 18, firstly, the depression portion 18b is elastically deformed, and by a further application of pressure, the depression piece 18c is elastically deformed to press the contact portion 7a. Thus, the contact portion 7a of the membrane switch 7 is pressed in two stages. This provides a softer tactile feeling.

Obviously, numerous modifications and variations of the present invention are possible in light of the above teachings. It is therefore to be understood that within the scope of the appended claims, the present invention may be practiced otherwise than as specifically described herein.

What is claimed is:

1. A key switch comprising:
a base plate;
a key top above the base plate;
a pair of link members supporting the key top and configured to operate in an interlocked manner to allow the key top to be lifted and lowered with respect to the base plate, one of the pair of link members comprising a projecting portion at a distal end of an arm of the link member, the other one of the pair of link members comprising a concave receiving portion at a distal end of an arm of the link member, the projecting portion being rotationally fitted to the concave receiving portion; and
a switch mechanism disposed between the base plate and the key top and configured to open and close a contact portion of an electric circuit in accordance with lifting and lowering operation of the key top.

2. The key switch according to claim 1, wherein the switch mechanism comprises
a sheet-shaped switch member disposed on an upper surface of the base plate and comprising a contact portion of an electric circuit,
a plate-shaped spring member above the contact portion of the electric circuit, and
a housing secured to the base plate and accommodating the plate-shaped spring member.

3. A key switch comprising:
a base plate;
a key top above the base plate;
a pair of link members supporting the key top and configured to operate in an interlocked manner to allow the key top to be lifted and lowered with respect to the base plate; and
a switch mechanism disposed between the base plate and the key top and configured to open and close a contact portion of an electric circuit in accordance with lifting and lowering operation of the key top, the switch mechanism comprising:
a sheet-shaped switch member disposed on an upper surface of the base plate and comprising a contact portion of an electric circuit;
a plate-shaped spring member above the contact portion of the electric circuit; and
a housing secured to the base plate and accommodating the plate-shaped spring member.

4. The key switch according to claim 3, wherein one of the pair of link members comprises a projecting portion at a distal end of an arm of the link member, the other one of the pair of link members comprises a concave receiving portion at a distal end of an arm of the link member, and the projecting portion is rotationally fitted to the concave receiving portion.

5. The key switch according to claim 1,
wherein the arm of each of the pair of link members comprises a distal end section rotationally supported by the housing,
wherein each link member comprises a rear end section supported by the key top, and
wherein, when the key top is at an upper limit position of lifting and lowering operation, the pair of link members are configured to form a V-shape.

6. The key switch according to claim 3,
wherein each of the pair of link members comprises an arm comprising a distal end section rotationally supported by the housing,
wherein each link member comprises a rear end section supported by the key top, and
wherein, when the key top is at an upper limit position of lifting and lowering operation, the pair of link members are configured to form a V-shape.

7. The key switch according to claim 1,
wherein the projecting portion on one of the link members comprises a columnar portion at a distal end, and
wherein the concave receiving portion on the other one of the link members comprises a curved inner circumferential portion corresponding to an arc shape of the columnar portion.

8. The key switch according to claim 4,
wherein the projecting portion on one of the link members comprises a columnar portion at a distal end, and
wherein the concave receiving portion on the other one of the link members comprises a curved inner circumferential portion corresponding to an arc shape of the columnar portion.

9. The key switch according to claim 2, wherein the plate-shaped spring member comprises a depression portion comprising a hole and configured to be elastically deformed.

10. The key switch according to claim 3, wherein the plate-shaped spring member comprises a depression portion comprising a hole and configured to be elastically deformed.

11. The key switch according to claim 2, wherein the plate-shaped spring member comprises
a depression portion configured to be elastically deformed, and
a depression piece disposed at a part of the depression portion and configured to press the contact portion of the electric circuit.

12. The key switch according to claim 3, wherein the plate-shaped spring member comprises
a depression portion configured to be elastically deformed, and
a depression piece disposed at a part of the depression portion and configured to press the contact portion of the electric circuit.

13. The key switch according to claim 11, wherein the depression piece comprises a punched and bent piece at a central portion of the depression portion.

14. The key switch according to claim 12, wherein the depression piece comprises a punched and bent piece at a central portion of the depression portion.

15. The key switch according to claim 1, wherein the base plate comprises a stopper configured to control an upper limit position during lifting and lowering operation of the key top, and when the pair of link members are rotated, the distal end of at least one of the link members is configured to abut against the stopper.

16. The key switch according to claim 3, wherein the base plate comprises a stopper configured to control an upper limit position during lifting and lowering operation of the key top, and when the pair of link members are rotated, a distal end of at least one of the link members is configured to abut against the stopper.

17. The key switch according to claim 2, wherein the housing comprises
a frame comprising a recess accommodating the plate-shaped spring member, and
a sheet-shaped member comprising an upper surface comprising a projection at a position corresponding to a depression portion of the plate-shaped spring member, the sheet-shaped member covering the recess of the frame.

18. The key switch according to claim 3, wherein the housing comprises
a frame comprising a recess accommodating the plate-shaped spring member, and
a sheet-shaped member comprising an upper surface comprising a projection at a position corresponding to a depression portion of the plate-shaped spring member, the sheet-shaped member covering the recess of the frame.
